(19) United States
(12) Patent Application Publication
(10) Pub. No.: US 2024/0304923 A1
(43) Pub. Date: Sep. 12, 2024

(54) BATTERY PACK

(71) Applicant: HONDA MOTOR CO., LTD., Tokyo (JP)

(72) Inventors: Yasuyuki SHIBATA, Tokyo (JP); Koki KAWASE, Tokyo (JP)

(73) Assignee: HONDA MOTOR CO., LTD., Tokyo (JP)

(21) Appl. No.: 18/590,143

(22) Filed: Feb. 28, 2024

(30) Foreign Application Priority Data
Mar. 10, 2023 (JP) 2023-037649

(51) Int. Cl. H01M 50/242; B60R 16/033; H01M 50/258; H01M 50/262; H01M 50/293; H01M 50/298

(52) U.S. Cl. CPC H01M 50/242; H01M 50/258; H01M 50/262; H01M 50/293; H01M 50/298; B60R 16/033

(57) ABSTRACT

A battery pack includes a battery module, a battery case accommodating the battery module, and a wiring or a pipe, disposed inside the battery case. The battery case includes a bottom surface, a side wall standing from an outer edge portion of the bottom surface, and a cross member disposed across left and right side walls facing each other. The cross member includes a member main body formed by aluminum die casting together with at least a part of the bottom surface and the side wall, and a reinforcing plate installed on an upper surface of the member main body. The member main body includes a recessed portion in a central portion of the battery case. The wiring or the pipe is provided between the member main body and the reinforcing plate.

### CROSS-REFERENCE TO RELATED APPLICATIONS

This application is based on and claims priority under 35 USC 119 from Japanese Patent Application No. 2023-037649 filed on Mar. 10, 2023, the entire content of which is incorporated herein by reference.

### TECHNICAL FIELD

The present disclosure relates to a battery pack to be mounted on a vehicle.

### BACKGROUND ART

In recent years, efforts to realize a low carbon social or a decarburized social have been activated, and research and development have been performed on an electrification technique in order to reduce CO₂ emissions and improve energy efficiency even in vehicles.

Batteries play an important role in the electrification technique. Since the battery is a high-voltage component, it is necessary to protect the battery from an impact. However, when the battery is mounted on a vehicle, a larger load may be input to the battery in a collision or the like. In the related art, a battery case made of iron has been used to protect the battery from a collision load.

In order to extend a cruising distance of the vehicle, it is important to reduce the weight of the vehicle. For example, JP2022-097816A discloses that a portion of a side member of a battery case is formed by drawing out an aluminum alloy that is a material lighter than iron.

A cooling pipe, a power line, a wiring such as a signal line, and the like are routed inside the battery case. When such pipe and wiring are routed above the battery, the height of the battery pack is increased. In a case where the battery pack is disposed under a floor of the vehicle, when the height of the battery pack is increased, a sufficiently wide vehicle compartment protruding to the vehicle compartment side might not be secured.

### SUMMARY OF INVENTION

The present disclosure provides a battery pack capable of protecting a battery from a side collision and of being reduced in size and weight.

An aspect of the present disclosure relates to a battery pack including:
a battery module;
a battery case accommodating the battery module; and
a wiring or a pipe, disposed inside the battery case,
in which the battery case includes:
   a bottom surface;
   a side wall standing from an outer edge portion of the bottom surface; and
   a cross member disposed across left and right side walls facing each other,
in which the cross member includes:
   a member main body formed by aluminum die casting together with at least a part of the bottom surface and the side wall; and
   a reinforcing plate installed on an upper surface of the member main body,
in which the member main body includes a recessed portion in a central portion of the battery case, and
in which the wiring or the pipe is provided between the member main body and the reinforcing plate.

According to the present disclosure, the height of the battery pack can be reduced, and the weight of the battery pack can be reduced, and an input load of the side collision can be appropriately received in the battery case.

### BRIEF DESCRIPTION OF DRAWINGS

Exemplary embodiment(s) of the present invention will be described in detail based on the following figures, wherein:

FIG. 1 is a perspective view of a battery case 30 constituting a battery pack 10; and

FIG. 2 is an enlarged view showing a space portion 55 of a first cross member 331.

### DESCRIPTION OF EMBODIMENTS

An embodiment of a battery pack according to the present disclosure will be described with reference to the drawings.

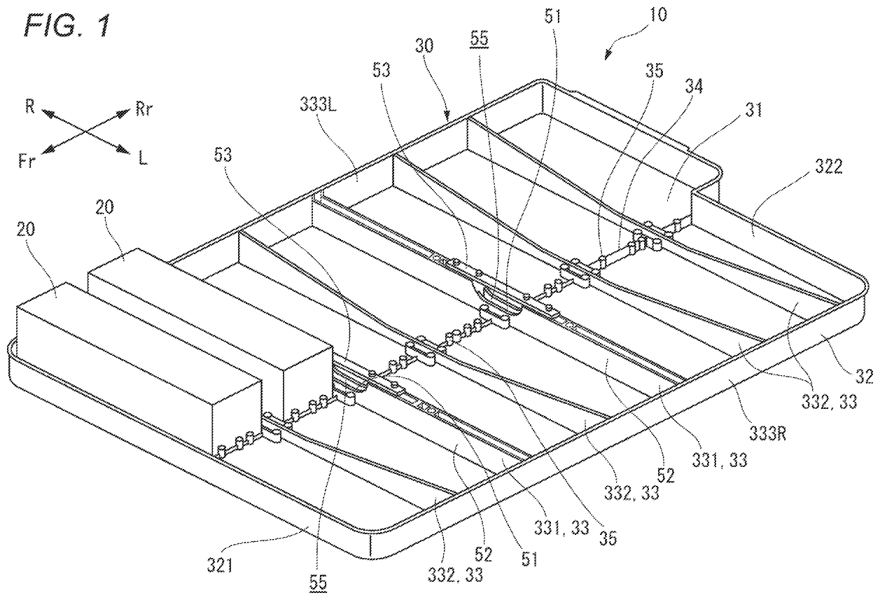

As shown in FIG. 1, a battery pack 10 includes a plurality of battery modules 20 and a battery case 30 that accommodates the plurality of battery modules 20. In FIG. 1, only two battery modules 20 are shown, and the other battery modules 20 are omitted. The number and arrangement of the battery modules 20 accommodated in the battery case 30 may be set as appropriate.

The battery case 30 includes a rectangular bottom plate 31 on which the plurality of battery modules 20 are mounted, a side wall 32 standing from an outer edge portion of the bottom plate 31, and a plurality of cross members 33.

The side wall 32 includes a front plate 321 constituting a front wall of the battery case 30, a rear plate 322 constituting a rear wall thereof, a left side plate 333L constituting a left wall thereof, and a right side plate 333R constituting a right wall thereof.

The cross members 33 include first cross members 331 and second cross members 332 each having a shape different from that of the first cross member 331. The cross member 33 according to the present embodiment has two first cross members 331 and four second cross members 332, and the second cross members 332 and the first cross members 331 are alternately arranged in order from the front, and two second cross members 332 are arranged behind the second first cross member 331. The number and arrangement of the first cross members 331 and the second cross members 332 may be changed as appropriate.

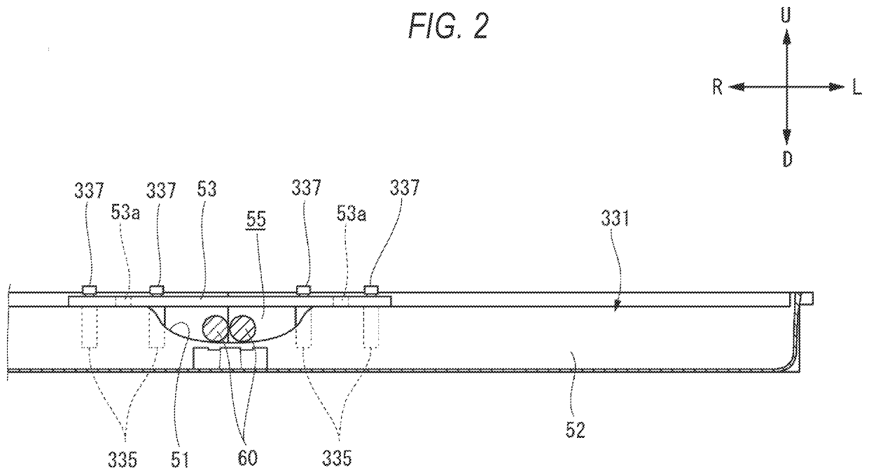

Referring also to FIG. 2, each of the first cross members 331 includes a cross member main body 52 having a recessed portion 51 in a central portion thereof, and a reinforcing plate 53 installed on an upper surface of the cross member main body 52 so as to cover the recessed portion 51.

In the cross member main body 52, two plate-shaped members connecting the left side plate 333L and the right side plate 333R are disposed to face each other in a front-rear direction with a predetermined gap therebetween. In the cross member main body 52, a plurality of (four in the present embodiment) nut portions 335 are formed between the plate-shaped members on both left and right sides of the recessed portion 51.

The reinforcing plate 53 installed on the upper surface of the cross member main body 52 is a plate-shaped member formed of high-tensile steel, and has a length in a left-right direction shorter than that of the cross member main body 52. The reinforcing plate 53 is fastened to nut portions 335 provided on the cross member main body 52 with bolts 337, and fixed to the cross member main body 52. A width (front-rear direction length) of the reinforcing plate 53 is substantially equal to a width (front-rear direction length) of the cross member main body 52.

As shown in FIG. 1, each of the second cross members 332 is configured to be inclined from the left side plate 333L and the right side plate 333R such that a height thereof decreases toward a central portion. The height of the central portion of the second cross member 332 is substantially equal to a height of the recessed portion 51 of the cross member main body 52 constituting the first cross member 331.

The second cross member 332 is not provided with the reinforcing plate 53. The reinforcing plate 53 is provided on a part of the plurality of cross members 33, that is, on the first cross member 331 only.

The battery case 30 is formed of an aluminum alloy containing aluminum except for the reinforcing plate 53 of the first cross member 331. More specifically, the bottom plate 31, the side wall 32, the cross member main body 52 of the first cross member 331, and the second cross member 332 of the battery case 30 are formed by aluminum die casting. The aluminum die casting is formed by melting an aluminum alloy, filling the aluminum alloy into a metal mold at a high speed using a die casting machine, and then applying a high pressure.

In the battery case 30, the bottom plate 31, the side wall 32, the cross member main body 52 of the first cross member 331, and the second cross member 332 of the battery case 30 may be integrally molded, or may be divided into two, three, or the like and then joined. However, the cross member main body 52 of the first cross member 331 is formed by aluminum die casting together with at least a part of the bottom plate 31 and at least a part of the side wall 32.

Since the battery case 30 is formed of an aluminum alloy lighter than iron in this manner, the weight of the battery case 30 can be reduced compared to a battery case using an iron plate material. Further, since most of the battery case 30 is formed by aluminum die casting, a process of joining sheet metal members to each other can be omitted or simplified.

In recent years, since the battery pack 10 has increased in size and weight, the cross member 33, which is a framework member of the battery case 30, needs to have high strength. Among them, when the battery case 30 is changed from iron to an aluminum alloy in order to reduce the weight of the battery case 30, the strength decreases at the same thickness, and in order to obtain the same strength as that of the high-tensile steel with an aluminum alloy, it is necessary to increase the height of the cross member 33. However, when the height of the cross member 33 is increased, the battery pack 10 protrudes toward a vehicle compartment side. Since only the reinforcing plate 53 is made of high-tensile steel and most of the battery case 30 is made of aluminum alloy, a load at the time of a side collision can be received by both the cross member main body 52 of the first cross member 331 and the second cross member 332 integrally formed with the bottom plate 31 and the reinforcing plate 53 provided on the first cross member 331.

Inside the battery case 30, a refrigerant pipe for supplying a refrigerant to a water jacket for cooling the battery module 20 and discharging the refrigerant from the water jacket and/or a wiring for connecting the battery module 20 inside the battery case 30 and a DC wire outside the battery case 30 are arranged. Hereinafter, these wirings or pipes are referred to as wirings 60. When the wirings 60 are routed above the cross member 33, the wirings 60 protrude upward and the battery pack 10 protrudes toward the vehicle compartment side.

The wirings 60 are disposed in the space portion 55 formed between the cross member main body 52 and the reinforcing plate 53. More specifically, the wirings 60 are disposed in the space portion 55 formed between the recessed portion 51 of the cross member main body 52 and the reinforcing plate 53. Accordingly, it is possible to prevent the wirings 60 from protruding upward.

Since the first cross member 331 has substantially the same height regardless of a position of the first cross member 331 in the left-right direction, a position of a cross-sectional center in a height direction is substantially constant. When the position of the cross-sectional center in the height direction is different depending on the position in the left-right direction, a moment is generated when an impact load is input, and thus further reinforcement is required. The recessed portion 51 is provided in the cross member main body 52 constituting the first cross member 331, and the wirings 60 are routed in the space portion 55 formed between the recessed portion 51 and the reinforcing plate 53, so that the height of the cross-sectional center can be set substantially the same regardless of the position of the first cross member 331 in the left-right direction.

Since the height of the central portion of the second cross member 332 is substantially equal to the height of the recessed portion 51 of the cross member main body 52 constituting the first cross member 331, even if the wirings 60 are long members extending in the front-rear direction across the first cross member 331 and the second cross member 332, the wirings 60 can be routed in the front-rear direction in the battery pack 10 without changing a position in an upper-lower direction.

As shown in FIG. 2, it is preferable that the reinforcing plate 53 is provided with fixing portions 53a to which an electronic component is attached. Accordingly, a bracket for attaching the electronic component can be reduced in size. Each of the fixing portions 53a may be, for example, a female screw portion formed in the reinforcing plate 53 or a nut portion welded to the reinforcing plate 53. In addition, the bracket to which the electronic component is attached may be fastened to the nut portion 335 together with the bolt 337.

It is preferable that a rib 34 extending in the front-rear direction is formed in a central portion of the battery case 30 in the left-right direction. This improves the strength of the battery case 30. It is preferable that the rib 34 includes nut portions 35. A bracket or the like for fixing the wirings 60 can be fastened using the nut portions 35.

Although various embodiments have been described above with reference to the drawings, the present invention is not limited to these examples. It is apparent to those skilled in the art that various changes or modifications can be conceived within the scope described in the claims, and it is understood that the changes or modifications naturally fall within the technical scope of the present invention. In addition, constituent elements in the embodiment described above may be freely combined without departing from the gist of the present invention.

In this specification, at least the following matters are described. Although corresponding constituent elements or the like in the embodiment described above are shown in parentheses, the present invention is not limited thereto.
(1) A battery pack (battery pack 10) including:
a battery module (battery module 20);
a battery case (battery case 30) accommodating the battery module; and
a wiring or a pipe (wirings 60), disposed inside the battery case,
in which the battery case includes:
   a bottom surface (bottom plate 31);
   a side wall (side wall 32) standing from an outer edge portion of the bottom surface; and
   a cross member (cross member 33) disposed across left and right side walls facing each other,
in which the cross member includes:
   a member main body (cross member main body 52) formed by aluminum die casting together with at least a part of the bottom surface and the side wall; and
   a reinforcing plate (reinforcing plate 53) installed on an upper surface of the member main body,
in which the member main body includes a recessed portion (recessed portion 51) in a central portion of the battery case, and
in which the wiring or the pipe is provided in a space portion (space portion 55) formed between the member main body and the reinforcing plate.

According to (1), the cross member is formed by aluminum die casting, and thus the weight of the battery pack can be reduced. Further, by installing the reinforcing plate on the upper surface of the cross member main body, a load at the time of a side collision can be received by both the cross member and the reinforcing plate formed integrally with the bottom surface. Accordingly, the load at the time of a side collision can be appropriately received while the height of the battery pack is kept low. At this point, if a cross-sectional center is shifted vertically depending on a position in the vehicle width direction, it is necessary to reinforce a portion shifted vertically in order to receive the side collision load. By forming the recessed portion in the member main body and forming the space portion through which the wiring or the pipe is passed by the reinforcing plate, the cross-sectional center is not shifted vertically depending on the position in the vehicle width direction, and an input load of the side collision can be more appropriately received.
(2) The battery pack according to (1),
in which a plurality of the cross members are provided, and
in which the reinforcing plate is provide on a part (first cross member 331) only out of the plurality of cross members.

According to (2), by arranging the reinforcing plate in a necessary portion only, it is possible to prevent an increase in the number of components and improve productivity.
(3) The battery pack according to (1),
in which the reinforcing plate is formed of high-tensile steel.

According to (3), strength can be secured with a small cross section by using the high-tensile steel.
(4) The battery pack according to (3),
in which the reinforcing plate is fixed to the cross member with a bolt (bolt 337).

According to (4), productivity is improved because the wiring or the pipe can be fixed after being attached.
(5) The battery pack according to (1),
in which the reinforcing plate is provided with a fixing portion (fixing portion 53a) to which an electronic component is attached.

According to (5), by attaching the electronic component using the reinforcing plate, it is possible to reduce a size of a bracket for attaching the electronic component.

What is claimed is:

1. A battery pack comprising:
a battery module;
a battery case accommodating the battery module; and
a wiring or a pipe, disposed inside the battery case,
wherein the battery case includes:
a bottom surface;
a side wall standing from an outer edge portion of the bottom surface; and
a cross member disposed across left and right side walls facing each other,
wherein the cross member includes:
a member main body formed by aluminum die casting together with at least a part of the bottom surface and the side wall; and
a reinforcing plate installed on an upper surface of the member main body,
wherein the member main body includes a recessed portion in a central portion of the battery case, and
wherein the wiring or the pipe is provided between the member main body and the reinforcing plate.

2. The battery pack according to claim 1,
wherein a plurality of the cross members are provided, and
wherein the reinforcing plate is provided on a part only out of the plurality of cross members.

3. The battery pack according to claim 1,
wherein the reinforcing plate is formed of high-tensile steel.

4. The battery pack according to claim 3,
wherein the reinforcing plate is fixed to the cross member with a bolt.

5. The battery pack according to claim 1,
wherein the reinforcing plate is provided with a fixing portion to which an electronic component is attached.
